(19) United States
(12) Patent Application Publication
(10) Pub. No.: US 2004/0083089 A1
(43) Pub. Date: Apr. 29, 2004

(54) System and method for coordinated operation or a plurality of computers

(75) Inventor: Brian K. Wade, Apalachin, NY (US)

Correspondence Address: Arthur J. Samodovitz, IBM Corporation, N50/040-4, 1701 North Street, Endicott, NY, 13760, US

(73) Assignee: International Business Machines Corporation, Armonk, NY

(21) Appl. No.: 10/280,977

(22) Filed: Oct. 24, 2002

(51) Int. Cl. G06F 13/10; G06F 15/16

(52) U.S. Cl. 703/21; 709/208

(57) ABSTRACT

A computer program product for execution at a first computer to emulate manual user input at a first computer to operate second and third computers. The program product includes a computer readable medium and the following programming recorded on the medium. A first program segment requests initialization of communication between the first computer and the second and third computers. A second program segment interacts with the second computer. A third program segment interacts with the third computer. The second program segment and the third program segment are executed effectively concurrently. According to the second program segment, execution of the second program segment is suspended pending the third computer reaching a certain state and the state being communicated to the second program segment. Such a state emulates human operator decisions and time that would be spent by the human operator in making operation decisions.

This invention relates generally to computer systems and networks and deals more particularly with systems and methods by which a single computer can control the operation of a plurality of other computers in a coordinated way.

One of the simplest ways in which humans can interact with computers is by way of line-mode commands and responses. This interaction begins with the human typing a command into the computer using a keyboard. The PC-DOS command “DIR”, the Unix command “Is”, and the CMS command “LISTFILE” are examples of such commands. The computer processes the command and then might print one or more lines of response text on a screen or on a roll of paper. The computer then issues a prompt (such as a question mark), indicating that it is ready for the next command.

Early computer networks extended this mode of interaction by offering the human operator the ability to use a local terminal and its associated local computer to issue commands to, and receive responses from, a remote computer. In such networks, a telecommunications protocol such as Telnet connects the local computer to the remote one. The data exchanged on the telecommunications link consists of the commands entered by the human operator on the local terminal and the responses generated by the remote computer. The local computer acts as intermediary between the human operator and the remote computer, forwarding commands from the local operator's terminal to the remote computer and printing the remote computer's responses on the local terminal. In this way the human operator conducts command-and-response interaction with the remote computer, the remote computer appearing to be local.

Telnet and similar protocols are often implemented on top of a generalized data exchange method, such as a TCP/IP socket connection. In such a case, a program running on the local computer can replace the local terminal and the local operator. The local program, being cognizant of the Telnet protocol, can use TCP/IP to connect to the remote computer, send it commands, and receive its responses. Further, the local program can decode those responses and condition subsequently transmitted commands on them. In other words, the local program controls the remote computer as a human operator might. The remote computer is unable to detect that it is being operated by a program running on the local computer, instead of by a human operator at the local terminal. In this scenario, when the local computer is exerting control over the remote computer, we call the local computer the “master” computer or “control” computer, and we call the controlled computer the “subordinate” computer.

One reason it is desirable for a master computer to operate a subordinate computer in this way is for the testing of programs within the subordinate computer for program debugging and other purposes. U.S. Pat. No. 5,371,883 discloses a method of testing programs in a distributed environment. A central repository is associated with a control computer for one of several computers to be tested. Test cases are stored in the central repository. The test cases are specific sequences of inputs or items of data which are designed to exercise a test program running in a test computer. A control program in the control computer forwards instructions from a test case to one or more test programs to be executed. In this manner, the control program maintains control of the sequence of execution. The results of the execution by the test programs are reported back to the control program which determines whether the results are correct. The control program may send additional instructions to the test programs depending on the foregoing results and startup parameters. In summary, the test program logs the results of the test cases, tracks the test cases that were performed and coordinates the test cases.

It is occasionally necessary to use the master computer to control a plurality of subordinate computers to operate in a concurrent, coordinated manner, instead of in a serial manner or in a concurrent but unrelated manner. For example, it might be desirable for the master computer to operate a suite of cooperating programs intended to run concurrently on the plurality of subordinates. If a human operator were performing this task, he might first type a “start” command on one subordinate, wait for said subordinate to indicate that it has started, and then type a corresponding “start” command on another subordinate. When a program replaces the human operator in this scenario, the program must issue the commands to the subordinates in the correct sequence, conditioning its actions on the timing of the receipt of appropriate responses from the subordinates.

Accordingly, an object of the present invention is to provide a program at a master computer to concurrently operate a plurality of cooperating programs at other computers in a manner which emulates human operation.

Another object of the present invention is to conduct such operation without requiring special coordination software in the subordinate computers.

### SUMMARY OF THE INVENTION

The invention resides in a computer program product for execution at a first computer to emulate manual user input at a first computer to operate second and third computers. The program product includes a computer readable medium and the following programming recorded on the medium. A first program segment requests initialization of communication between the first computer and the second and third computers. A second program segment interacts with the second computer. A third program segment interacts with the third computer. The second program segment and the third program segment are executed effectively concurrently. According to the second program segment, execution of the second program segment is suspended pending the third computer reaching a certain state and the state being communicated to the second program segment. Such a state emulates human operator decisions and time that would be spent by the human operator in making operation decisions based on current events.

According to one feature of the present invention, the computer programming includes

a first command to send a first request to the second computer and a second command subsequent to the first command to send a second request to the second computer. There is a third command, between the first and second commands, to wait a predetermined time until executing the second command. The predetermined time emulates a time that the human operator would wait before sending the second request to the second computer.

### BRIEF DESCRIPTION OF THE FIGURES

FIG. 1 is a block diagram illustrating a master computer, multiple interconnected subordinate computers, and key functions within the master computer according to the present invention.

FIGS. 2(a-e) form a flow chart of a Script Processing function within the master computer of FIG. 1, according to the present invention.

FIG. 3 illustrates scripts embodying various features of the present invention.

FIG. 4 is a timing diagram illustrating timing of events resulting from the scripts of FIG. 3.

FIGS. 5, 6, and 7 illustrate scripts embodying various features of the present invention.

### DETAILED DESCRIPTION OF THE INVENTION

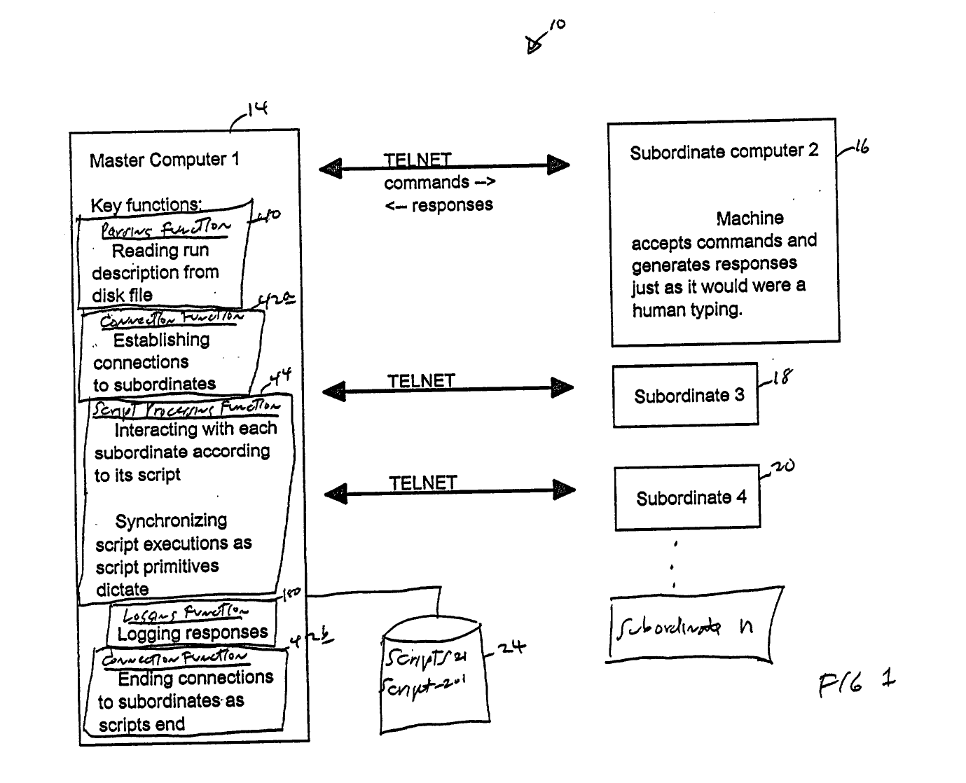

Referring now to the drawings in detail, wherein like reference numbers indicate like elements throughout, FIG. 1 illustrates a distributed computer system generally designated 10 embodying the present invention. System 10 comprises a master computer 14, subordinate computers 16, 18, 20, etc. and communication medium there between. By way of example, the communication medium is Telnet although other known protocols and interfaces will also suffice. Master computer 14 includes several functions pertaining to the present invention. The functions together comprise an interpreter for a script which a user writes with an ordinary text editor such as Notepad.

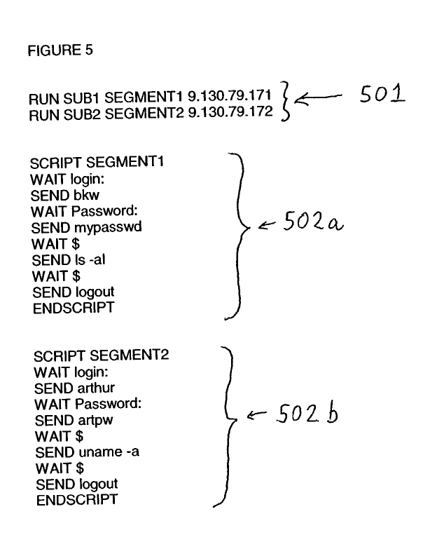

The script begins with initialization as illustrated in FIG. 5. Initialization step 501 identifies each subordinate to which the master computer is to connect. For each such subordinate, the initialization step gives the name by which the subordinate will be known in the rest of the script (in 501, “SUB 1” and “SUB2”). Further, continuing the Telnet example, the initialization section identifies each subordinate by IP address, so as to let the master establish a connection to the subordinate (connection parameters associated with other protocols would be appropriate if the other protocols were used in place of Telnet). Finally, for each subordinate, the initialization step names a later “script segment”. A script segment 502a or 502b is a programmatic sequence of commands, expected responses, and other control words which collectively describe how the master is to interact with a subordinate. In many cases the programmatic sequence contains control words describing how the progress of the interaction with a subordinate is to depend on the progress of the interactions with other subordinates. In general, a script will consist of one initialization section and one or more script segments. The master computer executes the script to exercise the subordinate computers 16, 18, and 20 as if the commands had been input by human operators seated at terminals directly attached to each of those subordinates.

It is important to realize that depending on the content of initialization step 501, a script segment 502a might apply to more than one subordinate although there would be a different instance of the script for each subordinate. For example, if the script author wanted the master computer to conduct exactly the same command-and-response conversation with 100 subordinates concurrently, he or she would write initialization step 501 to name each of the 100 subordinates and point each one to the very same script segment 502a. In this case the master computer would instantiate script segment 502a on each of the 100 subordinate connections. This is analogous to what happens on a Unix or Windows computer when the same program file runs concurrently in a plurality of processes.

Each script segment comprises one or more lines of code. Each script line includes a control “verb” and one or more parameters as appropriate for the verb. For example, a “Send” verb is a command to transmit a line of text to the respective subordinate. The line of text is indicated by a parameter associated with the verb. A “Wait” verb indicates that a certain text string must be received from the respective subordinate computer before interaction with the subordinate can continue. The text string is indicated by a parameter associated with the “Wait” verb. Other verbs, as described below, influence the ordering or timing of the transmissions to the subordinates. In other words, these other verbs define prerequisites for sending commands to the respective subordinate computers. These prerequisites includes the passage of time or the receipt of requisite responses from one or more other subordinate computers.

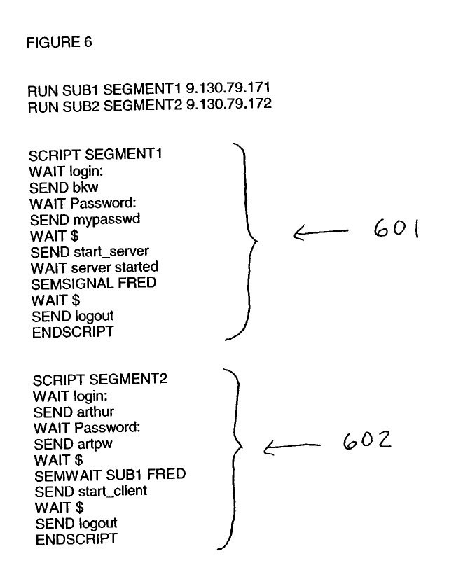

The ordering and timing of the processing of “Send” verbs emulates the decision-making process of a single human operator controlling the subordinate computers manually. For example, when attempting to generate computing load on a single subordinate, a human operator might type a command to start a load-inducing program, wait for the program to finish, delay some amount of time, and then type the load-inducing command again. A script segment emulating this would contain the “Send” and “Wait” verbs described earlier. The segment would contain an additional verb, “Delay”, that caused the master to wait a certain amount of time before proceeding. Finally, the segment would contain some iteration verbs, perhaps to cause the master to enter the load-inducing command 1000 times. In another example, in operating a distributed application, a human operator might need to type commands on a plurality of subordinates, in a specific sequence, so as to operate the distributed application correctly. The operator might need to type “start_server” on subordinate 16, wait for subordinate 16 to respond “server started”, and only then type “start_client” on subordinate 18. A script emulating this human operator's behavior would contain two script segments, one for subordinate 16 and the other for subordinate 18. Each segment would include “Send” and “Wait” verbs. The subordinate 18 segment would also contain a “SemWait” verb (described in more detail below), to cause interaction with subordinate 18 to be suspended until a semaphore has been signaled. The subordinate 16 script would also contain a “SemSignal” verb (described in more detail below), to signal the semaphore and thereby restart the interaction with subordinate 18 at the appropriate moment. FIG. 6, described below, with script segments 601 and 602 illustrates this.

Master computer 14's processing of a script begins when Parsing function 40 reads the script from a file, identifies the initialization section of the script, identifies each script segment, and determines the names of the subordinates and the correspondence between subordinates and script segments. Next, an Establish Connection function 42(a) establishes Telnet connections between master computer 14 and each of the subordinate computers identified in the initialization section, for example, subordinate computers 16, 18 and 20. Telnet connection establishment is well known and comprises the following steps. First, a TCP socket is obtained. The socket is used to connect to the Telnet port on the subordinate computer. Then, a small amount of data is sent to the subordinate computer to negotiate the Telnet connection parameters. As noted above, other communication protocols and interfaces can also be used. After these connections are established, a Script Processing function 44 begins using the Telnet connections to interact or “converse” with each subordinate according to the verbs in its designated script segment. The conversations with the subordinates are conducted concurrently. This concurrent execution can occur on different “threads” of a multithreaded master computer, if desired. Alternatively, this concurrent execution can be carried out by a single, serial thread on the master computer, provided the master computer thread effectively divides its attention among the subordinates, in which case the execution is effectively concurrent. Script Processing function 44 sends commands to the subordinate computers according to the verbs defined in the script segments.

Occasionally a subordinate conversation reaches a point where, in accordance with the verbs in its designated script segment, the conversation must wait for an event, such as the lapse of a timer or the receipt of a signal from some other subordinate conversation. When such a point occurs, the master computer suspends its conversation with the subordinate and continues conversing with the others.

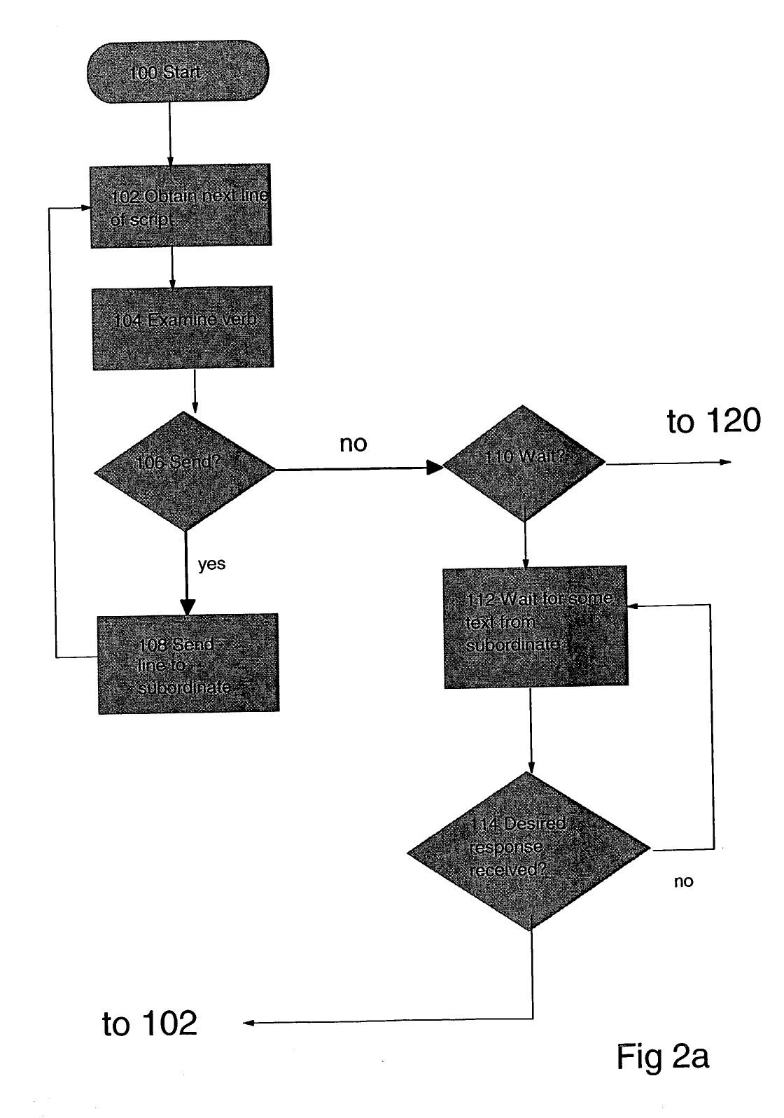

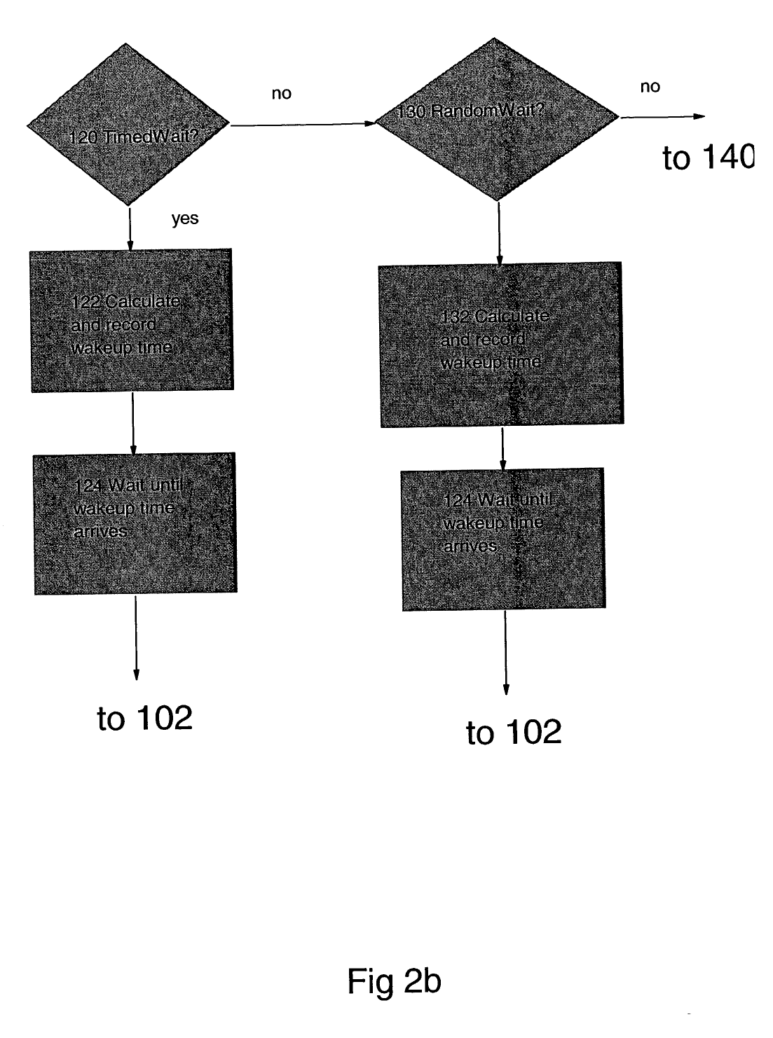

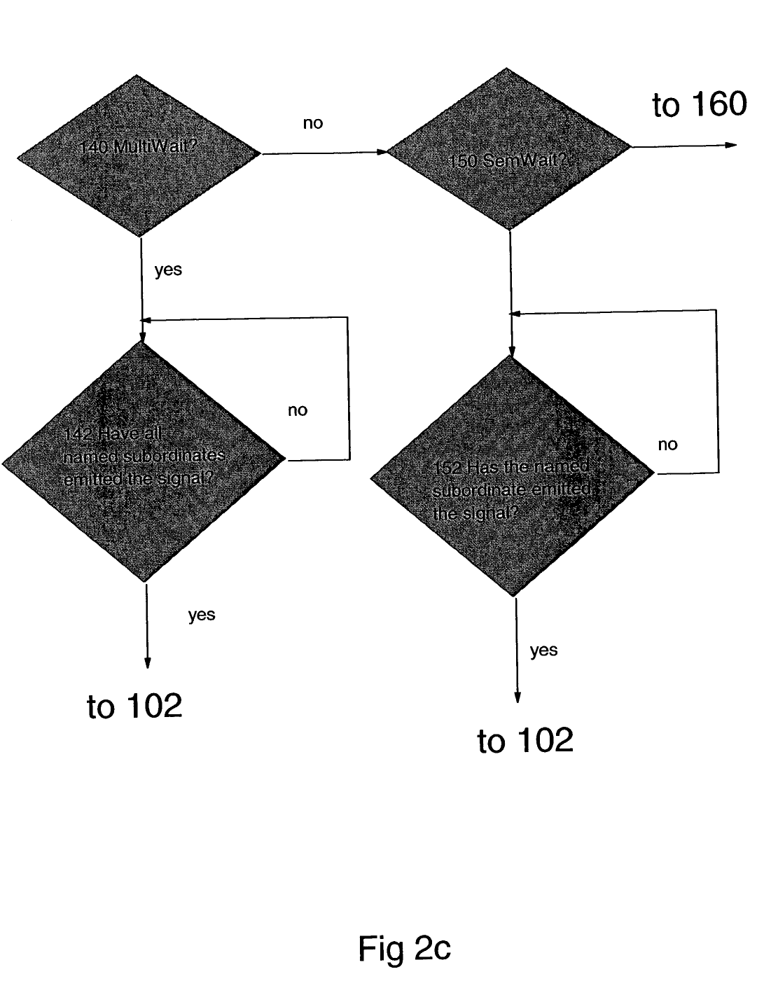

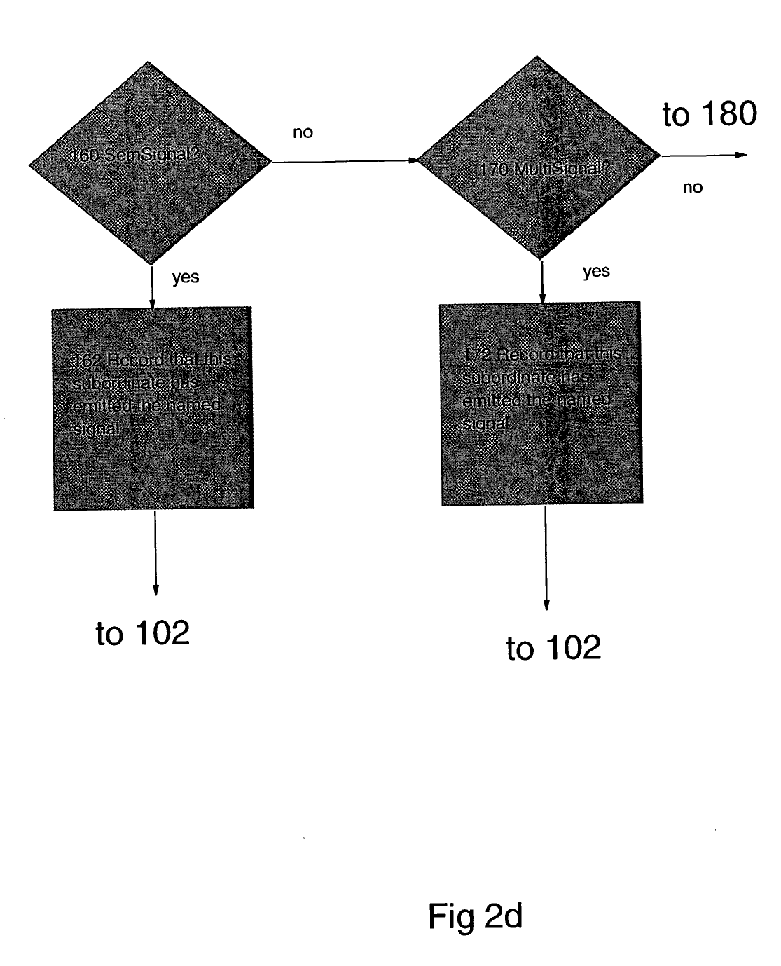

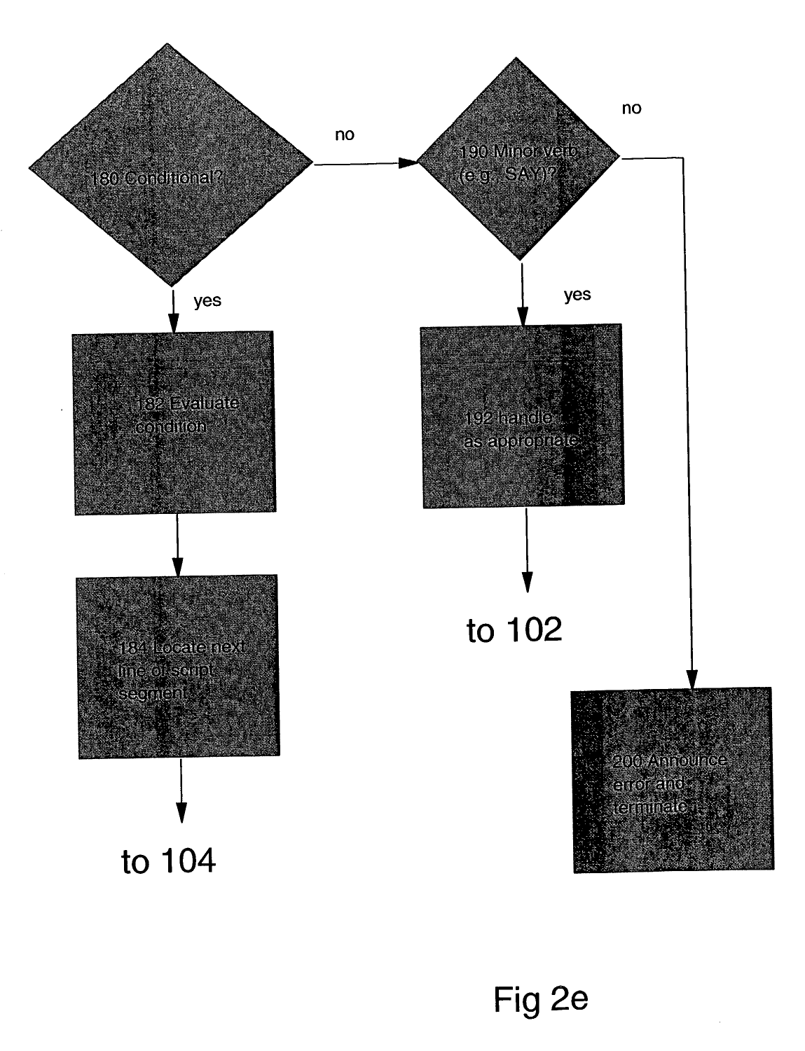

The Script Processing function 44 is further illustrated by the flowchart of FIG. 2 which is executed for each subordinate computer concurrently with that of the other subordinate computers. The general strategy of the Script Processing function is to advance each conversation with the respective subordinate computer as far as possible. When a subordinate conversation can no longer advance (for example, because its script segment requires a wait for a certain response text from the subordinate or a signal from another subordinate conversation), the master computer will suspend its interaction with that subordinate until the requisite event occurs.

For each subordinate conversation, the Script Processing function begins at step 100, where the conversation has just been started and is therefore advanceable. The Script Processing immediately moves to step 102, reading a line of the corresponding script segment to determine the nature of the line (step 104). This line will be the first line of the script segment if the conversation is just beginning or will be the next line for subsequent iterations of the flow chart of FIGS. 2(a) through 2(e). As noted above, each line from the script segment will consist of a verb and any parameters appropriate for the verb.

Each line from a script segment will contain one of the following dispatch control commands or “verbs”:

“Send” instructs the Script Processing function to send a line of text to the respective subordinate computer.

“Wait” instructs the Script Processing function to wait for the respective subordinate computer to emit a certain text string before proceeding. For example, if a human operator would ordinarily wait for a prompt string “Password:” before typing a logon password, the script segment would contain “WAIT Password:” to cause the master to wait for the string “Password:” before sending the password.

“TimedWait” instructs the Script Processing function to wait a certain amount of time before processing the next line of the script segment. The duration of the timer is specified as a parameter to the “TimedWait” verb. The “TimedWait” verb may be used in a script segment which emulates user think time. For example, the user may request data which is presented on a screen at his terminal, and the user must read the screen and decide what to do next before entering a new command. In this example, the “TimedWait” emulates the time required by the user to read the screen and decide what to do next.

“RandomWait”, like TimedWait, instructs the Script Processing function to wait some amount of time before processing the next line of the script segment. Unlike “TimedWait”, the amount of time to wait is random within a range prescribed by parameters to the “RandomWait” verb. A function within the master computer generates the random time. Like “TimedWait”, the “RandomWait” verb may be used in a script segment which emulates user think time because different (human) users will require different think times for any given scenario. “RandomWait” is probably more realistic than “TimedWait” for emulating think time, but nevertheless both verbs are provided.

“SemWait” instructs the Script Processing function to wait for a named signal from some other subordinate conversation before processing the next line of the script segment containing the “SemWait”. The identity of the subordinate conversation on which to wait and the name of the signal for which to wait are given as parameters to the “SemWait” verb. The “SemWait” verb may be used in a script which emulates a single user concurrently using two different keyboards to control two different subordinate computers. In this scenario, the user may wait on sending a command to one subordinate computer via one keyboard until having received and evaluated a response from another subordinate computer. The “SemWait” verb can emulate the decision making process of the user in sequencing the sending of commands through the two different keyboards.

“SemSignal” instructs the Script Processing function to provide a named signal so that one or more other subordinate conversations can proceed. Typically these other subordinate conversations are suspended waiting for this named signal pursuant to the foregoing “SemWait” verb. The provision of the “SemSignal” might enable these other subordinate conversations to proceed. The name of the signal to provide is given by a parameter to SemSignal. Typically, a script author will use SemSignal to let one or more subordinate conversations proceed after an appropriate response has been received from a certain subordinate. Each waiting subordinate conversation uses SemWait to listen for the named signal and proceed to the next line of its corresponding script segment only after it receives the signal. Step 601 of FIG. 6 illustrates the login of an emulated human operator named “bkw” and then the SemSignal verb. Step 602 of FIG. 6 illustrates the login of an emulated user “arthur” and then the corresponding SemWait verb. Thus, script segment 601 illustrates the use of SemSignal to provide signal “FRED” to script segment 602. Script segment 602 illustrates the use of SemWait to wait for subordinate SUB1 to provide signal “FRED”.

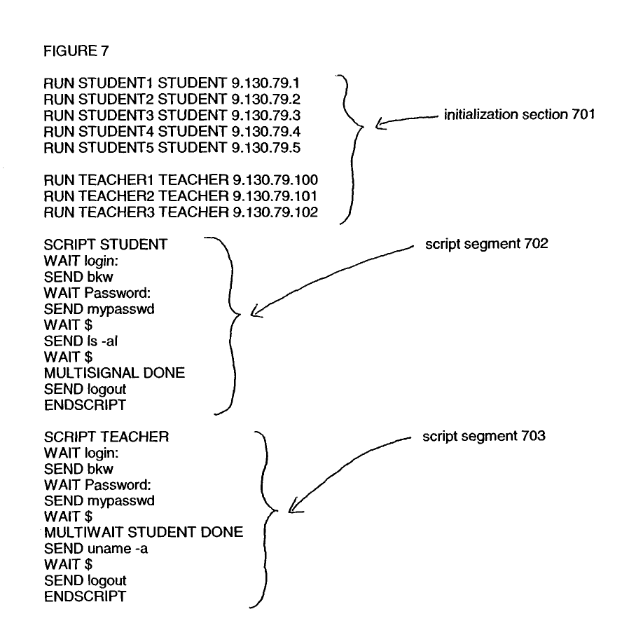

“MultiWait” instructs the Script Processing function to wait for all subordinate conversations sharing a given name prefix to provide a certain signal. The name prefix and the signal name are given by parameters to the MultiWait verb. The “MultiWait” verb is used to let one or more subordinate conversations wait for a whole class of subordinate conversations to reach a certain point, and only then do the waiting subordinate conversations continue processing. For example, in reference to FIG. 7, initialization step 701 defines five “STUDENT” subordinates, named STUDENT1, . . . , STUDENT5, all running script segment 702. Initialization step 701 also defines three “TEACHER” subordinates, named TEACHER1, . . . , TEACHER3, all running script segment 703. After emulation of login of user “bkw” with a password for all STUDENT and TEACHER subordinates, all STUDENT subordinates must finish “Is -al” before any TEACHER subordinate issues “uname -a”.

“MultiSignal” instructs the Script Processing function to provide the named signal, for capture by one or more other subordinate conversations' MultiWait verb. FIG. 7 also illustrates the use of MultiSignal, wherein each TEACHER subordinate is waiting for the “DONE” signal from each STUDENT subordinate before advancing.

Each “control directive” may also include one of the following control words or verbs which changes the Script Processing function's flow through the script segment, but is not directly related to advanceability of a subordinate conversation or the sending or receiving of data thereon:

“If” instructs the Script Processing function to branch within the script segment based on a condition specified as a parameter to the “If” directive. Processing either continues at the next line of the segment or branches to the corresponding “EndIf”, depending on the veracity of the specified condition.

“Do” instructs the Script Processing function to iterate over a portion of a script segment a certain number of times. The end of the sequence is marked by a corresponding “End” directive. The requisite number of iterations is given by a parameter to the “Do” verb.

“IfRun” instructs the Script Processing function to branch within the script segment based on whether the name of the subordinate conversation matches one of the subordinate name prefixes specified as a parameter to “IfRun”. If the subordinate name matches one of the prefixes, processing continues at the next line. If there is no match, control transfers to the corresponding “EndIfRun” directive.

Each “control directive” may also include one of the following control words or verbs which causes the Script Processing function to take specific immediate actions which do not bear on the interaction with the subordinate computers:

“Say” which instructs the Script Processing function to display specified text to a user of the master computer.

“Checkpoint” which instructs the Script Processing function to write to persistent storage (for example, a disk file) all of the subordinate responses it has received so far, so that in the event of a failure, some responses will have been saved.

As noted above, in step 104 the Script Processing function examines the “verb” in the script line. If the verb is “Send” (decision 106), then the Script Processing function sends the associated line of text (indicated by the parameter for the Send verb) to the subordinate (step 108). Then, the Script Processing function returns to step 102 to process the next line of this script segment. However, if the current line of the script segment does not contain a “Send” verb, then step 108 is bypassed, and the Script Processing function determines if the verb is “Wait” (decision 110). If so, the Script Processing function waits for some text to arrive from the subordinate associated with the script segment (step 112). To wait for some text, the Script Processing function uses the “wait for data” and “read data” functions provided by the data transport protocol being used. (In the Telnet example, the Script Processing function uses the TCP socket function “select( )” to wait for data to arrive from the subordinate, and it then uses the TCP socket function “read( )” to collect the arrived data. Those skilled in the art will recognize that other data transport means will have corresponding primitives which should be used in place of select( ) and read( ).) Whenever data arrives, the Script Processing function examines it to determine whether the desired text has arrived yet (step 114). When the desired text arrives, the Script Processing function loops back to step 102 to process more lines from the script segment.

If the line of the script segment does not contain any of the foregoing verbs, then the Script Processing function determines if the verb is “TimedWait” (decision 120). If so, the Script Processing function records the wakeup time for this subordinate conversation (step 122). The “wakeup” time for a “TimedWait” verb is based on a timer value specified as a parameter to the “TimedWait” verb. Next, the Script Processing function waits until the specified timer has expired (decision 124). At that time, the Script Processing function loops back to step 102 to process more lines from the script segment.

If the line of the script segment does not contain any of the foregoing verbs, the Script Processing function determines if the verb is “RandomWait” (decision 130). If so, the Script Processing function records the wakeup time for this subordinate conversation (step 132). The “wakeup” time for a “RandomWait” verb is based on a random time (within a specified range) generated by the Script Processing function. Next, the Script Processing function waits until the specified time has been reached (decision 134). At that time, the Script Processing function loops back to step 102 to process more lines from the script segment.

If the line of the script segment does not contain any of the foregoing verbs, the Script Processing function determines if the verb is “MultiWait” (decision 140). Such a script segment line will also specify the name prefix for the set of subordinates for which this conversation is waiting and the name of the signal all of these subordinates must provide before the script segment bearing the MultiWait can proceed. If the verb is a “MultiWait”, the Script Processing function checks whether all of the specified subordinates have already provided the named signal (step 142). If so, the Script Processing function loops back to step 102 to process the next line of the script segment. However, if at least one of the subordinates of the named set has not yet provided the named signal, the Script Processing function repeats step 142. When all subordinates of interest provide the named signal, the Script Processing function loops back to step 102 to process more lines from the script segment.

If the line of the script segment does not contain any of the foregoing verbs, the Script Processing function determines if the verb is “SemWait” (decision 150). Such a script segment line will also specify the name of the subordinate which will provide the signal and the name of the signal the subordinate will provide. If the verb is a “SemWait”, the Script Processing function checks whether the named subordinate has already provided the named signal (decision 152). If so, the Script Processing function loops back to step 102 to process the next line of the script segment. However, if the named subordinate has not yet provided the named signal, processing returns to decision 152. When the named subordinate provides the named signal, the Script Processing function loops back to step 102 to process more lines from the script segment.

If the line of the script segment does not contain any of the foregoing verbs, the Script Processing function determines if the verb is “SemSignal” (decision 160). If so, the Script Processing function records (step 162) that this subordinate conversation has provided the named signal. This will directly end the waiting of any subordinate conversation using SemWait (decision 152) to wait on this subordinate to emit this signal. The Script Processing function then loops back to step 102 to process more lines from the script segment.

If the line of the script segment does not contain any of the foregoing verbs, the Script Processing function determines if the verb is “MultiSignal” (decision 170). If so, the Script Processing function records (step 172) that this subordinate conversation has provided the named signal. Like SemSignal (step 162), this will contribute toward the advancement of one or more other subordinate conversations which were suspended at a MultiWait verb (decision 142). The Script Processing function then loops back to step 102 to process more lines from the script segment.

If the line of the script segment does not contain any of the foregoing verbs, then the Script Processing function determines if the verb is a conditional verb—“If”, “IfEnd”, “Do”, “End”, “IfRun” or “EndIfRun” (decision 180). If so, the Script Processing function evaluates the condition (step 182). In the case of an “If” verb, the script segment will also state the requisite condition. The Script Processing function will determine if the requisite condition has been satisfied and locate the appropriate next line of the script segment (step 184). The appropriate line is either the very next line of the script or the first line after the corresponding “EndIf”. In the case of a “Do” verb, the script segment will also state a number of iterations of a step or loop of steps to be performed, and the Script Processing function will iteratively execute them. The end of the block of script segment statements is marked by “End”. In the case of an “IfRun” verb, the script segment will also state the class of subordinates to which the steps apply. The Script Processing function will determine if the requisite condition has been satisfied and locate the appropriate next line of the script segment (step 184). The appropriate line is either the very next line of the script or the first line after the corresponding “EndIfRun”. For any of these conditionals, once it has located the appropriate next line, the Script Processing function returns to step 104 to evaluate the line.

If the line of the script segment does not contain any of the foregoing verbs, then the Script Processing function determines whether the verb is one of the minor verbs, such as “Say” or “Checkpoint” (decision 190). If so, the Script Processing function handles the verb accordingly (step 192) and then returns to step 102 to process more lines from the script segment.

If the line of the script segment does not contain any of the foregoing verbs, the Script Processing function displays an error message for the user of the master computer, halts its interactions with the subordinate computers, and terminates (step 200).

Based on the foregoing process, master computer 14 advances each subordinate conversation according to the instructions specified in its associated script segment. Subordinate conversations which have no requisite preconditions for completion or whose preconditions are satisfied from the outset may complete without ever waiting. Other subordinate conversations whose script segments include a “Wait” may be executed until reaching this verb, and then be suspended until receiving the requisite response from a subordinate computer. Other subordinate conversations whose script segments include a “TimedWait” or “RandomWait” verb may be executed until reaching these verbs, and then be suspended the requisite time before proceeding. Other subordinate conversations whose script segments include a “MultiWait” or “SemWait” verb may be executed until reaching this verb, and then be suspended until receiving a notification from one or more other subordinate conversations to proceed. Thus, the script and Script Processing function let a script author determine the timing and sequence in which commands will be sent to a plurality of subordinate computers.

Referring again to FIG. 1, during script processing, the Script Processing function notifies a Logging function 180 of the responses from the subordinates. The Logging function duly records them. After the Script Processing function completes each subordinate conversation, the Script Processing function notifies an End Connection function 42(b) to end the Telnet connection with the respective subordinate computer.

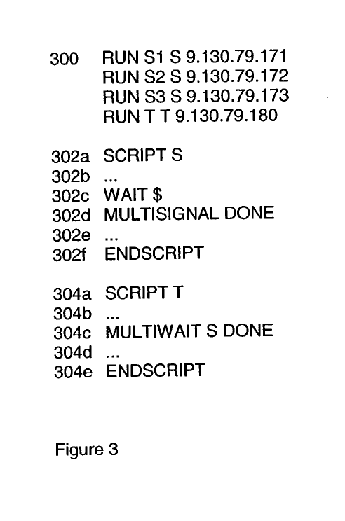

FIG. 3 illustrates a sample script that includes Wait, MultiWait, and MultiSignal verbs. The script begins with initialization step 300 which defines four subordinates followed by their respective IP addresses. Three of the subordinates are in class S and are named S1, S2, and S3. The other subordinate is named T. The script segment designated “S” is for each of the subordinates S1, S2 and S3. The script segment designated “T” is for subordinate T. Script segment S begins at step 302a, while script segment T begins at item 304a. All four script segments, i.e. three instances of script segment S and one instance of script segment T, execute concurrently. To process this script, the master computer runs its Parsing function 40 (from FIG. 1) so as to determine the identities of the subordinates and the script segments they are to run. The master computer next runs its Establish Connection function 42 (also from FIG. 1) so as to establish appropriate connections to the four subordinates. Next, the master computer begins its Script Processing function 44, conversing with the four subordinates concurrently. The Script Processing function advances each of the four subordinate conversations at its own pace, according to network speed, the speeds of the respective subordinate computers, and any wait conditions. With respect to each subordinate conversation S, the Script Processing function performs one or more steps 302b, whose contents are not relevant to this example, and then performs step 302c, wherein it waits for the subordinate to respond with text containing a dollar sign “$”. (Unix practitioners will recognize the “$” as the prompt character, indicating the computer is ready to process another command.) After the “$” is received, the Script Processing function moves to step 302d, at which it records that the respective subordinate has provided the signal “DONE”. With respect to its conversation with subordinate T, the Script Processing function in like manner has worked through steps 304a and 304b, and arrived at 304c. The Script Processing function cannot complete step 304c on its conversation with subordinate T until it has completed step 302d for each of its S1, S2, and S3 conversations, that is, until each of the S subordinates has emitted the “DONE” signal. Thus the master computer cannot advance its subordinate conversation T to step 304d until its conversations with S1, S2, and S3 have all completed step 302d. This achieves the synchronization of the operation of each of the four subordinate computers.

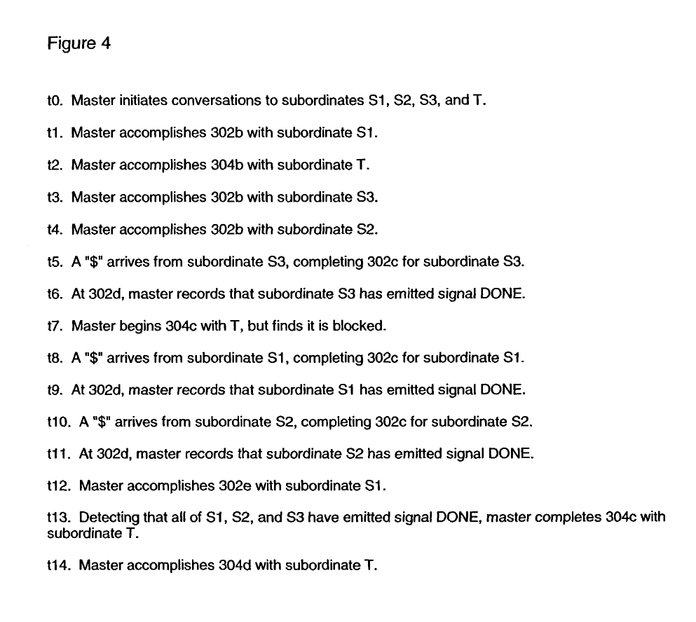

FIG. 4 illustrates one possible sequence of events that would satisfy the script of FIG. 3. The scenario begins at time t0 with the master establishing its connections to the four subordinates S1, S2, S3, and T. At times t1 through t4, the master accomplishes intermediate steps 302b and 304b with the four subordinates, the relative ordering and function actually performed by these steps not being relevant to the present example. At time t5 the master receives “$” from subordinate S3, thus satisfying the Wait at 302c, and so at time t6 accomplishes 302d for subordinate S3, recording provision of signal “DONE”. At time t7 the master begins step 304c for subordinate T, but finding the MultiWait condition unsatisfied, can advance its conversation with T no further. At times t8 through t11, the master detects receipt of “$” from subordinates S1 and S2 (step 302c) and records their provisions of signal “DONE” (step 302d). At this moment the conversation with subordinate T becomes advanceable, because all of the S subordinates have emitted “DONE”. However, at time t12 the Script Processing function continues with subordinate S1, accomplishing 302e, whose actual function is not relevant to the present example. At t13 the master computer detects that S1, S2, and S3 have all emitted the signal “DONE”, and so the Script Processing function completes step 304c with T. At time t14 the master computer completes step 304d with T. Beyond time t14 the master continues with subordinates S1, S2, S3, and T through the rest of their script segments, description thereof not being relevant in this example.

Based on the foregoing, a computer system and method embodying the present invention have been disclosed. However, numerous modifications and substitutions may be made without deviating from the present invention. For example, minor verbs other than “Say” and “Checkpoint” could be added, or the “Wait” verb could be enhanced to detect that a subordinate has not emitted the desired response within a specified period of time, or iteration and flow control verbs sensitive to subordinate response texts could be added. Therefore, the present invention has been disclosed by way of illustration and not limitation and reference should be made to the following claims to determine the scope of the present invention.

1. A computer program product for execution at a first computer to emulate manual user input at said first computer to operate second and third computers, said program product comprising:
a computer readable medium;
a first program segment to request initialization of communication between said first computer and said second and third computers;
a second program segment for interacting with said second computer; and
a third program segment for interacting with said third computer; and wherein
said second program segment and said third program segment are executed effectively concurrently;
according to said second program segment, execution of said second program segment is suspended pending said third computer reaching a certain state and said state being communicated to said second program segment, said suspension emulating waiting by said user at said first computer for said third computer to reach said certain state; and
after said certain state being communicated to said second program segment, resuming execution of said second program segment, said resumption emulating a decision by said user to resume execution of said second program segment based on said third computer reaching said certain state; and wherein
said first, second and third program segments are recorded on said medium.

2. A computer program product as set forth in claim 1 wherein said second program segment is a script segment and said third program segment is a script segment.

3. A computer program product as set forth in claim 1 wherein said third program segment makes said communication to said second program segment.

4. A first computer to emulate manual user input at said first computer to operate second and third computers, said first computer comprising:
means for executing a first program segment to request initialization of communication between said first computer and said second and third computers;
means for executing a second program segment to interact with said second computer; and
means for executing a third program segment to interact with said third computer; and wherein
said second program segment and said third program segment are executed effectively concurrently;
according to said second program segment, execution of said second program segment is suspended pending said third computer reaching a certain state and said state being communicated to said second program segment, said suspension emulating waiting by said user at said first computer for said third computer to reach said certain state; and
after said certain state being communicated to said second program segment, resuming execution of said second program segment, said resumption emulating a decision by said user to resume execution of said second program segment based on said third computer reaching said certain state.

5. A computer program product for execution at a first computer to emulate user input at said first computer to operate a second computer, said computer program product comprising:
a computer readable medium;
a first program segment comprising:
a first command to send a first request to said second computer;
a second command subsequent to said first command to send a second request to said second computer;
a third command, between said first and second commands, to wait until receiving a first signal before executing said second command; and
a second program segment comprising:
a fourth command emulating a decision by said user to execute said second command, said fourth command emitting said first signal when said user would decide to execute said second command; and wherein
said first and second program segments are executed concurrently at said first computer; and
said first and second program segments are recorded on said medium.

6. A computer program product for execution at a first computer to emulate user input at said first computer to operate a second computer, said computer program product comprising:
a computer readable medium;
a first program segment comprising a first command to send a first request to said second computer, said first program waiting for a first signal before executing said first command;
a second program segment comprising:
a second command emulating a decision by said user to execute said first command, said second command emitting said first signal when said user would decide to execute said first command, said first signal being accessible or received by said first program segment; and wherein
said first and second program segments are executed concurrently at said first computer; and
said first and second program segments are recorded on said medium.
